(19) United States
(12) Patent Application Publication
(10) Pub. No.: US 2002/0181105 A1
(43) Pub. Date: Dec. 5, 2002

(54) Long period grating and making method of the same

(76) Inventors: Michiko Takushima, Yokohama-shi (JP); Masakazu Shigehara, Yokohama-shi (JP)

Correspondence Address: MCDERMOTT WILL & EMERY, 600 13TH STREET, N.W., WASHINGTON, DC, 20005-3096, US

(21) Appl. No.: 10/082,134

(22) Filed: Feb. 26, 2002

(30) Foreign Application Priority Data
Feb. 26, 2001 (JP) P2001-049665

(51) Int. Cl. G02B 5/18

(52) U.S. Cl. 359/575

(57) ABSTRACT

In the long period grating, a plurality of the first areas are discretely arranged in a predetermined range along the longitudinal direction of a silica-based optical fiber, which includes the core area, where GeO₂ has been added, and the clad area surrounding this core area, wherein the refractive index at each position in the first area is modulated to be the refractive index that is the same as the refractive modulated with the first period all through the predetermined range.

### BACKGROUND OF THE INVENTION

1. Field of the Invention

The present invention relates to a long period grating where the refractive index is modulated in a predetermined range along the longitudinal direction of the optical wave guide for transforming core mode light into clad mode light, and a method of making such long period grating.

2. Related Background Art

In a long period grating, long period (several hundred μm period) refractive index is modulated in a predetermined range along the longitudinal direction of the optical wave guide (optical fiber or plane optical wave guide). By transforming a core mode light with a specific wavelength into a clad mode light using the refractive index modulation, the specific wavelength light is leaked from the core to the clad. Such a long period grating is used as a light filter since it causes a loss to a specific wavelength of light selectively out of the incident lights. Also the long period grating is characterized by non-reflection, so in the wavelength division multiplexing (WDM) optical transmission system, it can be suitably used as a gain equalizer which equalizes the gain of a light amplifier.

A long period grating, where refractive index is modulated with a predetermined period, has one loss peak, which has a shape approximated by a Gaussian function, in the wavelength band of signal light used for normal optical communication. Whereas the gain equalizer for a light amplifier must have a loss spectrum having the same shape of the gain spectrum which the light amplifier has, and must have a loss spectrum having a shape where a plurality of loss peaks, which loss peak wavelengths are different from each other, are superimposed. Therefore the long period grating, which is suitably used for a gain equalizer, can be implemented by cascade-connecting a plurality of long period gratings, where refractive index is modulated with different period, by fusion splice or another means.

### SUMMARY OF THE INVENTION

However, a conventional long period grating having a plurality of loss peak wavelengths is large in size, since a plurality of long period gratings are cascade-connected. Particularly when a plurality of long period gratings are connected by fusion splice, extra length is required for the fusion splice, which makes its size even longer.

With the foregoing in view, it is an object of the present invention to solve the above problem and to provide a small size long period grating which has a plurality of loss peak wavelengths in a signal light wavelength band, and a making method of the same.

A long period grating according to the present invention is a long period grating where a refractive index at a predetermined range is periodically modulated at a several hundred μm order along the longitudinal direction, wherein a plurality of first areas are arranged discretely in the predetermined range, and the refractive index of each position in these first areas is modulated to a refractive index that is the same as the refractive index is modulated at a first period all through the predetermined range.

This long period grating has a loss peak due to the first period refractive modulation, which are formed in the plurality of first areas respectively in the above mentioned predetermined range, and a loss peak due to the discrete arrangement of the plurality of first areas in the above mentioned predetermined range. The wavelength of the former loss peak is determined depending on the first period. The wavelength of the latter loss peak is determined depending on the arrangement of the plurality of first areas. By setting these appropriately, this long period grating can have a plurality of loss peaks in the wavelength band of the signal light used in normal optical communication, and the size thereof can be decreased.

It is preferable that the deviation of the lengths of the first areas and the deviations of the lengths between them are smaller than double that of the first period. In this case, the first areas are arranged at a predetermined period with substantially the same predetermined length. In the above mentioned predetermined range, the wavelength of the loss peak due to a discrete arrangement of the plurality of first areas can be adjusted by appropriately setting this length and period.

It is preferable that the amplitude of the refractive index modulation of each area of the first areas is the same as one another, since the average refractive index in each of the plurality of the first areas becomes constant.

It is also preferable that the long period grating further comprises one or more area groups, wherein a plurality of areas are discretely arranged in an area other than the first areas in the predetermined range, and the refractive index at each position of each area has been modulated to a refractive index which is the same as the refractive index modulated at a unique period, which is different from the first period, all through the predetermined range. In this case, the long period grating has a loss peak due to the refractive index modulation formed in each area of each area group in the above mentioned predetermined range, and also has a loss peak due to the discrete arrangement of the areas of each area group in the above mentioned predetermined range.

It is preferable that the areas of each group are sequentially arranged without a space, since the size of the long period grating can be decreased.

If the deviation of the lengths of each area and the deviation of the lengths between them are set to values smaller than double that of the refractive index period of the area, then the areas of each group can be regarded as being arranged at a predetermined duty ratio with a predetermined length. And the wavelength of the loss peak due to the discrete arrangement of the areas of each group in the above mentioned predetermined range is adjusted by setting the period of [these areas] in the arrangement appropriately.

It is preferable that the amplitude of the refractive index modulation of each one of the areas is the same for each within a same group, since the average refractive index in each area in a same group becomes constant. And it is preferable that that of the refractive index modulation of an entire area is the same for each in an entire area since the average refractive index in the entire area becomes constant.

A making method of a long period grating according to the present invention is a method for making the above mentioned long period grating according to the present invention, comprising steps of preparing a first intensity modulation mask where a mask pattern is created according to a predetermined period in an entire area along a predetermined range, and a second intensity modulation mask where light blocking sections are arranged between a plurality of light transmission sections along a predetermined range, overlaying these two intensity modulation masks on each other and placing them on a processing target optical wave guide, and creating long period gratings by irradiating the refractive index change inducing light, which is transmitted through these two masks, on the optical wave guide to cause the refractive index change.

It is also possible to create a plurality of groups of long period gratings by preparing a plurality of masks with different mask patterns as first intensity modulation masks, preparing a plurality of masks with a different arrangement of light transmission sections as second intensity modulation masks, and repeating the arrangement of masks and irradiation of refractive index change inducing light by changing the combination of the first intensity modulation mask and the second intensity modulation mask.

### BRIEF DESCRIPTION OF THE DRAWINGS

FIG. 1 is a diagram showing the first embodiment of a long period grating according to the present invention.

FIG. 2 is a diagram showing the refractive index modulation thereof;

FIG. 3 and FIG. 4 are diagrams showing examples of the transmission characteristic of the long period grating of the first embodiment;

FIG. 5 is a diagram showing the general transmission characteristics when the long period grating of the comparison example 1 and the long period grating of the comparison example 2 are connected by fusion splice;

FIG. 6 is a diagram showing the second embodiment of the long period grating according to the present invention;

FIG. 7 is a diagram showing an example of the transmission characteristic of the long period grating in FIG. 6;

FIG. 8 is a diagram showing the general transmission characteristics when the long period grating of the comparison example 3A and the long period grating of the comparison example 3B are connected by fusion splice;

FIG. 9A to FIG. 9C are diagrams showing the intensity modulation masks to be used for manufacturing the long period grating in FIG. 6;

FIGS. 10A and 10B and FIGS. 11A and 11B are diagrams showing the manufacturing method for the long period grating in FIG. 6; and

FIG. 12 is a diagram showing the third embodiment of the long period grating according to the present invention, and FIG. 13 is a diagram showing an example of the transmission characteristic thereof.

### DESCRIPTION OF THE PREFERRED EMBODIMENTS

Preferred embodiments of the present invention will now be described with reference to the accompanying drawings. To facilitate the comprehension of the explanation, the same reference numerals denote the same parts, where possible, throughout the drawings, and a repeated explanation will be omitted. The dimensional ratio in each drawing may be partially exaggerated for the description, and do not always match the actual dimensional ratio.

(First Embodiment)

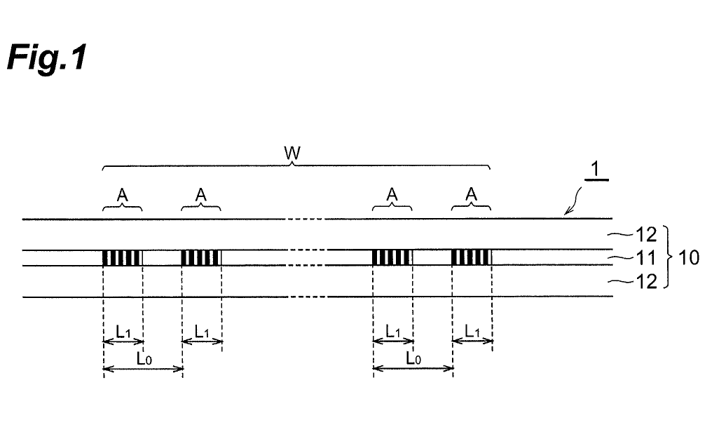

The first embodiment of the long period grating according to the present invention will be described first. FIG. 1 is a diagram showing the long period grating 1 of the first embodiment. FIG. 1 shows a cross-section when the long period grating 1 is cut at the plane which includes the optical axis. In the long period grating 1 shown in FIG. 1, refractive index modulation with a first period Λ₁ are formed at a plurality of first areas A respectively of the core area 11, in a predetermined range W along the longitudinal direction of the silica-based optical fiber 10, which includes the core area 11, where GeO₂ has been added, and a clad area 12 surrounds this core area 11.

If the z axis is set in the longitudinal direction (optical axis direction), then the refractive index modulation f(z) at the position z in the predetermined area W is given by the product of the first square wave function F₁(z) and the period function F₂(z), that is, F₁(z)=F₁(z) F₂(z). Here the first square wave function F₁(z) is a function given by

F₁(z)=1 (within area A)

F₁(z)=0 (outside area A) (1)

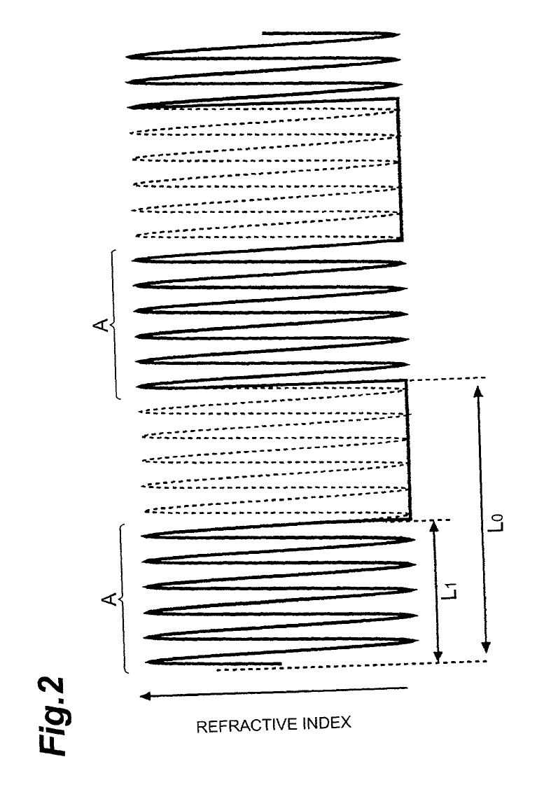

The period function F₂(z) is a period function F₂(z) having a predetermined first period Λ₁, and is given by

$${F}_{2} ( z ) = Δ {n}_{UV} ( 1 + cos \frac{2 π}{{Λ}_{1}} z ) \qquad ( 2 )$$

where the amplitude of the refractive index modulation is a constant Λn_{UV}. FIG. 2 is a diagram showing the refractive index modulation of the long period grating 1 according to the first embodiment. In FIG. 2, a sold line corresponds to the refractive index modulation f(z), and a dashed line corresponds to the period function F₂(z). In other words, the refractive index at each position in the first area A is the same as the case when the refractive index modulation is set by the period function F₂(z).

Here it is assumed that a plurality of the first areas A are arranged at a predetermined period L₀ and the length of the plurality of the first areas A is L₁ respectively, as shown in FIG. 1. At this time, the above equation (1) becomes a square wave function where the period is L₀ and the duty ratio is L₁/L₀, so a Fourier series expansion is possible. And the refractive index modulation f(z) in the predetermined range W is given by

$$f ( z ) = Δ {n}_{UV} ( 1 + cos \frac{2 π}{{Λ}_{1}} z ) \frac{{L}_{1}}{{L}_{0}} + Δ {n}_{UV} {\sum }_{m = 1}^{∞} ( \frac{2}{m π} sin \frac{m π {L}_{1}}{{L}_{0}} cos \frac{2 m π}{{L}_{0}} z ) + Δ {n}_{UV} cos \frac{2 π}{{Λ}_{1}} z {\sum }_{m = 1}^{∞} ( \frac{2}{m π} sin \frac{m π {L}_{1}}{{L}_{0}} cos \frac{2 m π}{{L}_{0}} z ) \qquad ( 3 )$$

In the case of prior art where the refractive index is modulated with a first period Λ₁ with amplitude Λn_{UV} all through the predetermined range W, on the other hand, the refractive index modulation f₀(z) is given by

$${f}_{0} ( z ) = Δ {n}_{UV}^{′} ( 1 + cos \frac{2 π}{{Λ}_{1}} z ) \qquad ( 4 )$$

Comparing the equation (3) and the equation (4), the following becomes clear. The first term of the right side of the equation (3) becomes the same as the equation (4) by setting the refractive index modulation amplitude Λn_{UV} appropriately. Therefore in the long period grating 1 according to the present embodiment, the loss peak due to the first term of the right side of the equation (3) can have the same shape as the loss peak in the conventional long period grating, where the refractive index modulation is given by the equation (4).

The second term of the right side of the equation (3) is the period component of the square wave function F₁(z) of the equation (1). Since the relationship between L₀ and Λ₁ is

L₀>>Λ₁ (5)

the second term of the right side of the equation (3) influences the loss characteristic at the longer wavelength then the wavelength of the loss peak due to the first term.

The third term of the right side of the equation (3) can be transformed to be

$$\frac{Δ {n}_{UV}}{2} {\sum }_{m = 1}^{∞} [ \frac{2}{m π} sin \frac{m π {L}_{1}}{{L}_{0}} \{ cos 2 π ( \frac{1}{{Λ}_{1}} + \frac{m}{{L}_{0}} ) z + cos 2 π ( \frac{1}{{Λ}_{1}} - \frac{m}{{L}_{0}} ) z \} ] \qquad ( 6 )$$

In other words, the third term of the right side of the equation (3) provides a loss peak due to the beat of the period Λ₁ and period M/L₀. Therefore, the long period grating 1 according to the present embodiment can have not only a loss peak based on the first term of the right side of the equation (3), but can also have a loss peak based on the third term of the right side of the equation (3) in the wavelength band of the signal light used for normal optical communication (e.g. 1520 nm-1600 nm) by setting the value L₀ appropriately.

In the above description, the first square wave function F₁(z) has period L₀ and duty ratio L₁/L₀. However, the first square wave function F₁(z) may have period L₀ and duty ratio L₁/L₀ only if the deviation of the length L₁ of each one of the plurality of first area A is smaller than the double of the first period Λ₁, and if the deviation of the lengths between each area of the plurality of the first areas A is smaller than the double of the first period Λ₁. Also in the above description, the period function F₂(z) of the first period Λ₁ has equal refractive index modulation in each one of the plurality of first areas A. This is preferable because the average refractive index in each one of the plurality of first areas A becomes constant.

Now examples (example 1 and example 2) of the long period grating 1 according to the first embodiment will be described.

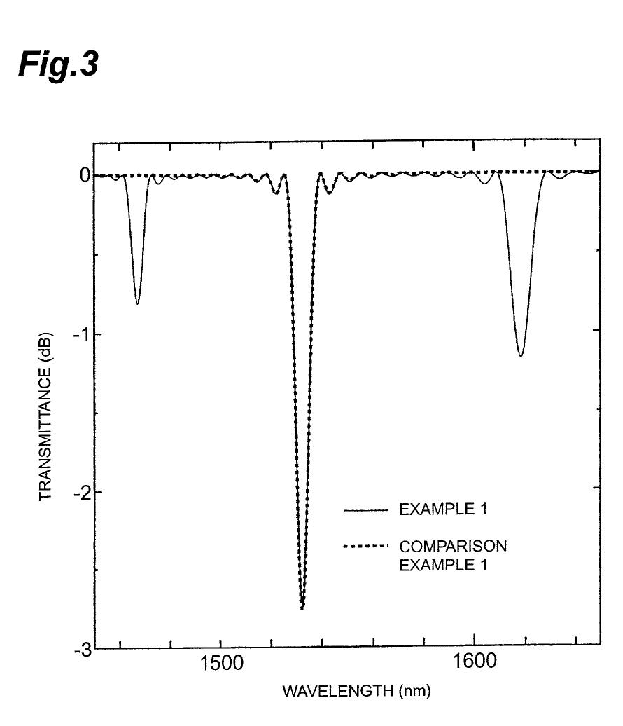

FIG. 3 is a diagram showing the transmission characteristic of the long period grating of example 1. In the long period grating of example 1, L₀=4 mm, L₁=2 mm, Λ₁=360 μm, the number of the first areas A is 10, and the length of the predetermined range W is 38 mm. The transmission characteristic of the long period grating of the example 1 is indicated by the solid line in FIG. 3. The dashed line in FIG. 3 indicates the transmission characteristic of the long period grating (the refractive index modulation with a predetermined period are created all through the 38 mm length) of the comparison example 1.

As FIG. 3 shows, the long period grating of the example 1 has a peak at around wavelength 1530 nm, just like the long period grating of comparison example 1. The loss peak at around the wavelength 1530 nm is based on the first term of the right side of the equation (3). The long period grating of the example 1 also has loss peaks at around the wavelengths 1465 nm and 1620 respectively, unlike the long period grating of the comparison example 1. These loss peaks are based on the third term of the right side of the equation (3).

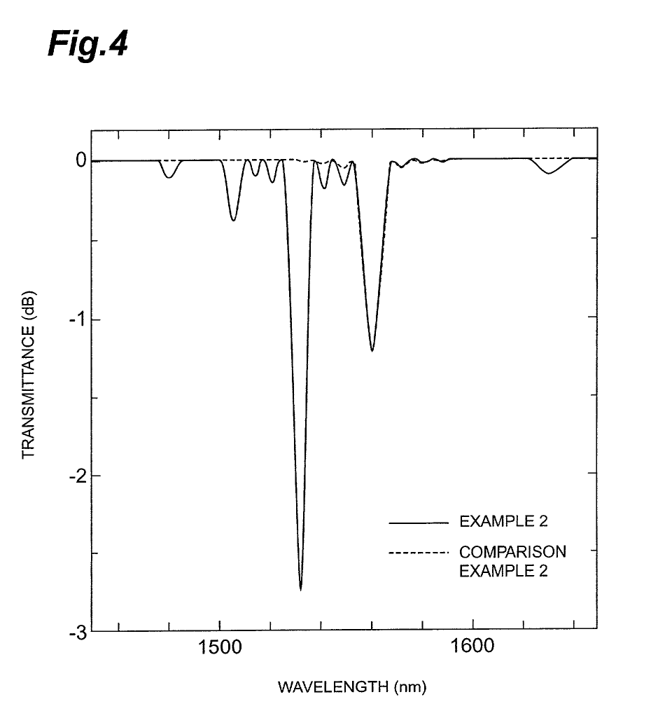

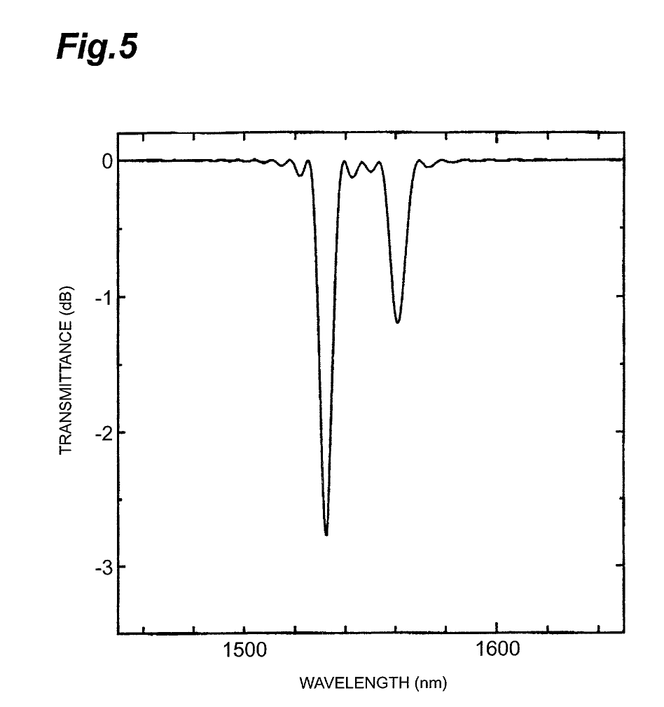

FIG. 4 is a diagram showing the transmission characteristic of the long period grating of the example 2. In the long period grating of the example 2, L₀=10.6 mm, L₁=6.1 mm, Λ₁=360 μm, the number of the first areas A is 4, and the length of the predetermined range W is 38 mm. The transmission characteristic of the long period grating of the example 2 is indicated by the solid line in FIG. 4. The dashed line in FIG. 4 indicates the transmission characteristic of the long period grating (the refractive index modulation with a predetermined period 373.5 μm are created all through the 38 mm length) of the comparison example 2. FIG. 5 shows a general transmission characteristic when the long period grating of the comparison example 1 and the long period grating of the comparison example 2 are connected by fusion splice.

As FIG. 4 shows, the long period grating of the example 2 has a loss peak at around the wavelength 1530 nm (based on the first term of the right side in the equation (3)), and also has loss peaks at around the wavelengths 1505 nm and 1560 nm respectively (based on the third term of the right side of the equation (3)). Also as the comparison between FIG. 4 and FIG. 5 shows, in the wavelength band of the signal light used for normal optical communication (e.g. 1520 nm to 1600 nm), the transmission characteristic of the long period grating of the example 2 is roughly the same as the general transmission characteristic when the long period grating of the comparison example 1 and the long period grating of the comparison example 2 are connected by fusion splice. In this way, the long period grating of the example 2 has a small size, even if a plurality of loss peak wavelengths exist in the signal light wavelength band.

(Second Embodiment)

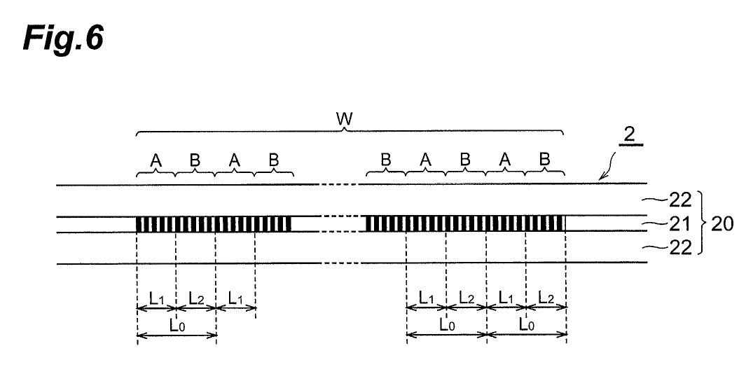

The second embodiment of the long period grating according to the present invention will now be described. FIG. 6 is a diagram showing the long period grating 2 of the second embodiment. FIG. 6 shows a cross-section when the long period grating 2 is cut at the plane which includes the optical axis. In the long period grating 2 shown in FIG. 6, refractive index modulation with a first period Λ₁ are created at each one of the plurality of first areas A of the core area 21 in a predetermined range W along with the longitudinal direction of the silica-based optical fiber 20, which includes the core area 21, where GeO₂ has been added, and a clad area 22 surrounding this core area 21, and the refractive index modulation with the second period Λ₂ is created in each one of the plurality of second areas B of the core area 21. The first areas A and the second areas B do not overlap with each other, but are created alternately along the longitudinal direction. The first period Λ₁ and the second period Λ₂ are different from each other.

In a predetermined range W, the refractive index modulation in each one of the plurality of first areas A is given, in the same manner as in the first embodiment, by the product of the first square wave function, where the value in the first area A is 1 and the value in the other area is 0, and the period function of the first period Λ₁. In the same way, in the predetermined range W, the refractive index modulation in each one of the plurality of second areas B is given by the product of the second square wave function, where the value in the second area B is 1 and the value in the other area is 0, and the period function of the second period Λ₂. By this, the refractive index in each area becomes the same refractive index and the same modulation pattern at a position the same as when a predetermined range W is modulated by the refractive index modulation pattern that has a predetermined period function.

It is preferable that the first square wave function has period L₀ and duty ratio L₁/L₀. However, if the deviation of the lengths L₁ of each one of the plurality of first areas A is smaller than double that of the first period Λ₁, and the deviation of the lengths between each area of the plurality of the first areas A is smaller than the double of the first period Λ₁, then the first square wave function may have period L₀ and duty ratio L₁/L₀. In the same way, it is preferable that the second square wave function has period L₀ and duty ratio L₂/L₁. However, if the deviation of lengths L₂ of each one of the plurality of second areas B is smaller than double that of the second period Λ₂, and the deviation of the lengths between each area of the plurality of second areas B is smaller than double that of the second period Λ₂, then the second square wave function may have period L₀ and duty ratio L₂/L₀.

It is also preferable that for the period function of the first period Λ₁, the amplitude of the refractive index modulation is the same in each one of the plurality of the first areas A. In the same way, it is preferable that for the period function of the second period Λ₂, the amplitude of the refractive index modulation is the same in each one of the plurality of second areas B. Also it is preferable that the amplitude of the refractive index modulation in each one of the plurality of first areas A and the amplitude of the refractive index modulation in each one of the plurality of second areas B are the same.

For the transmission characteristic of the long period grating 2 according to the present embodiment, a component due to the refractive index modulation in each one of the plurality of first areas A and a component due to the refractive index modulation in each one of the plurality of second areas B are superimposed. The component due to the refractive index modulation in each one of the plurality of first areas A is the same as that shown in the first embodiment. The component due to the refractive index modulation in each one of the plurality of second areas B is also the same as that shown in the first embodiment.

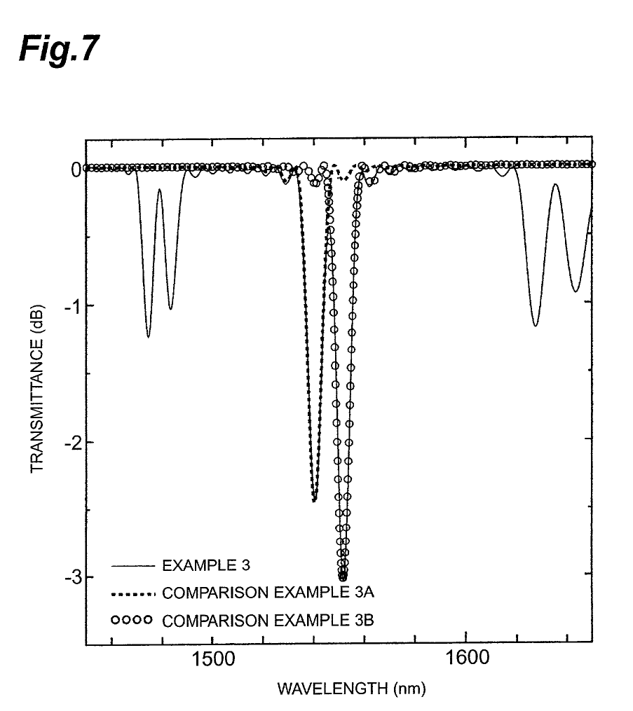

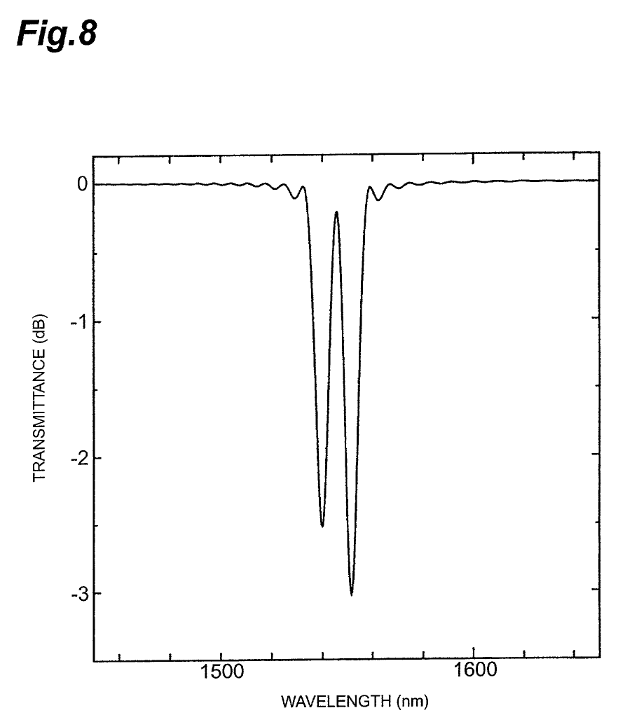

Now an example (example 3) of the long period grating 2 according to the second embodiment will be described. FIG. 7 is a diagram showing the transmission characteristic of the long period grating in example 3. In the long period grating in example 3, L₀=4 mm, L₁=2 mm, L₂=2 mm, ζ₁=360 μm, Λ₂=365 μm, the number of the first areas A is 10, the number of the second areas B is 10, and the length of the predetermined range W is 40 mm. The transmission characteristic of the long period grating in the example 3 is indicated by the solid line in FIG. 7. FIG. 7 also shows the transmission characteristic of the long period grating (a refractive index modulation with a predetermined period 363 μm are created all through the 40 mm length) of the comparison example 3A, and the transmission characteristic of the long period grating (a refractive index modulation with a predetermined period 368 μm are created all through the 40 mm length) of the comparison example 3B. FIG. 8 is a diagram showing the general transmission characteristic when the long period grating in the comparison example 3A and the long period grating in the comparison example 3B are connected by fusion splice.

As FIG. 7 shows, the long period grating in the example 3 has loss peaks at around wavelengths 1540 nm and 1550 nm respectively, (based on the first term of the right side of the equation (3)). The loss peak at around the wavelength 1540 nm is due to the refractive index modulation with the first period Λ₁ in the first area A. The loss peak at around the wavelength 1550 nm is due to the refractive index modulation with the second period Λ₂ in the second area B.

The long period grating in example 3 also has loss peaks at around the wavelengths 1475 nm, 1485 nm, 1625 nm and 1640 nm respectively (based on the third term of the right hand side of the equation (3)). These loss peaks can exist in the signal light wavelength band by appropriately setting L₀.

As the comparison of FIG. 7 and FIG. 8 shows, in the signal light wavelength band used for normal optical communication, the transmission characteristic of the long period grating in the example 3 is roughly the same as the general transmission characteristic when the long period grating in the comparison example 3A and the long period grating of the comparison example 3B are connected by fusion splice. In this way, the long period grating in the example 3 has a small size, even if a plurality of loss peak wavelengths exist in the signal light wavelength band.

Whereas the period Λ₁ of the refractive index modulation in the first area A of the long period grating in the example 3 is 360 μm, the period of the refractive index modulation in the long period grating in the comparison example 3A is 363 μm, so the period is longer in the comparison example 3A. Whereas the period Λ₂ of the refractive index modulation in the second area B of the long period grating in the example 3 is 365 μm, and the period of the refractive index modulation in the long period grating in the comparison example 3B is 368 μm, so the period is longer in the comparison example 3B. This is because the example 3 implements a similar transmission characteristic as the comparison examples 3A and 3b with shorter length, so the amplitude of the refractive index modulation is large and the average refractive index is large. In other words, the average refractive index differs between the comparison examples 3A and 3B and the example 3, so the period of the refractive index modulation must be different accordingly.

In order to prevent the appearance of peaks by the beat of the grating period and the repeat period in the wavelength band in use, the following four equations must be satisfied.

$$\begin{matrix}\frac{{Λ}_{1} {L}_{0}}{{L}_{0} + {Λ}_{1}} < {Λ}_{S} & ( 7 ) \\ \frac{{Λ}_{2} {L}_{0}}{{L}_{0} + {Λ}_{2}} < {Λ}_{S} & ( 8 ) \\ {Λ}_{L} < \frac{{Λ}_{1} {L}_{0}}{{L}_{0} - {Λ}_{1}} & ( 9 ) \\ {Λ}_{L} < \frac{{Λ}_{2} {L}_{0}}{{L}_{0} - {Λ}_{2}} & ( 10 )\end{matrix}$$

Here Λ_{S} and Λ_{L} are the refractive index periods of the long period grating which are required for obtaining a loss peak at the shortest wavelength and the longest wavelength respectively in the bands in use.

The left side of the equation (7) and (8) and the right side of the equations (9) and (10) are periods due to the beat component of the grating period and the repeat period L₀ respectively, and corresponds to the inverse number of the value inside the parenthesis in the equation (6) respectively. The equations (7) and (9) and the equations (8) and (10) are simplified as follows.

$$\frac{{Λ}_{L} {L}_{0}}{{L}_{0} + {Λ}_{L}} < {Λ}_{1} , {Λ}_{2} < \frac{{Λ}_{S} {L}_{0}}{{L}_{0} - {Λ}_{S}}$$

Now the making method for the long period grating 2 according to the second embodiment will be described. In the making method to be described here, the long period grating 1 of the first embodiment is obtained first, and the long period grating 2 of the second embodiment is obtained by processing this.

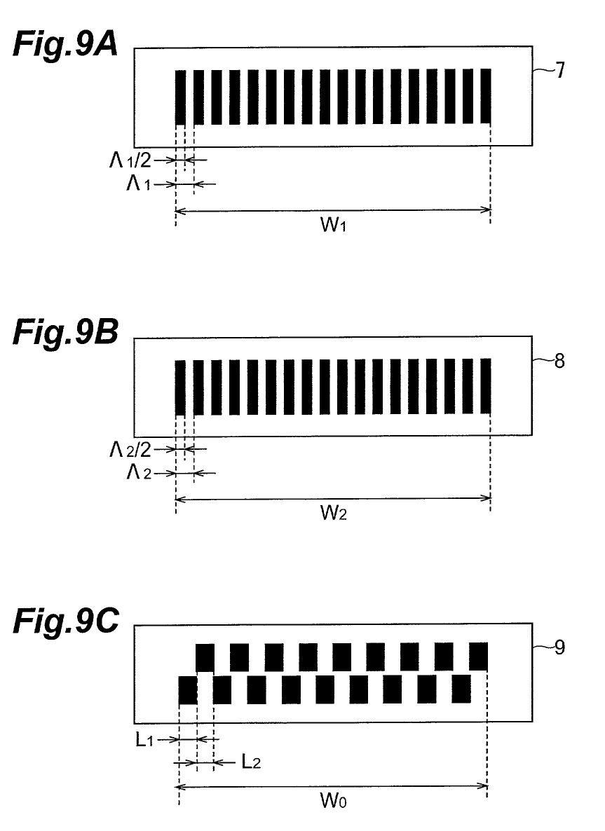

FIG. 9A to FIG. 9C are diagrams showing the intensity modulation masks to be used for manufacturing the long period grating 2 according to the second embodiment. The intensity modulation mask 7 shown in FIG. 9A is a mask where areas for blocking the refractive index change inducing light (e.g. areas on which chromium oxide is deposited) are created in stripes with period Λ₁ in a range with a length W₁, (W₁>W) in a predetermined direction on one face of a flat plate made from a material which is transparent with respect to the refractive index change inducing light (e.g. silica-based glass). Here the refractive index change inducing light is a light with a wavelength which can increase the refractive index of the silica-based glass where GeO₂ has been added, and is an ultra-violet laser beam with a 248 nm wavelength, which is output from a KrF excimer laser light source, for example. The intensity modulation mask 8 shown in FIG. 9B is a mask where areas for blocking the refractive index change inducing light are created in stripes with period Λ₂ in a range with a length W₂(W₂>W) in a predetermined direction on one face of a flat plate made from a material which is transparent with respect to the refractive index change inducing light.

The intensity modulation mask 9 shown in FIG. 9C is a mask where the areas for blocking the refractive index change inducing light (light blocking sections) are created in stripes in two parallel rows with period L₀ in a range with a length W₃ (W₃>W) in a predetermined direction on one face of a flat plate made from a material which is transparent with respect to the refractive index change inducing light. In the first row, the length of the area to block the refractive index change inducing light (length along the above mentioned direction) is L₁, and in the second row, the length of the area to block the refractive index change inducing light (length along the above mentioned direction) is L₂. The areas to block the refractive index change inducing light in the first row and the areas to block the refractive index change inducing light in the second row are disposed alternately when viewed along the above mentioned predetermined direction. The sections between each light block section are created as light transmission sections which transmit light.

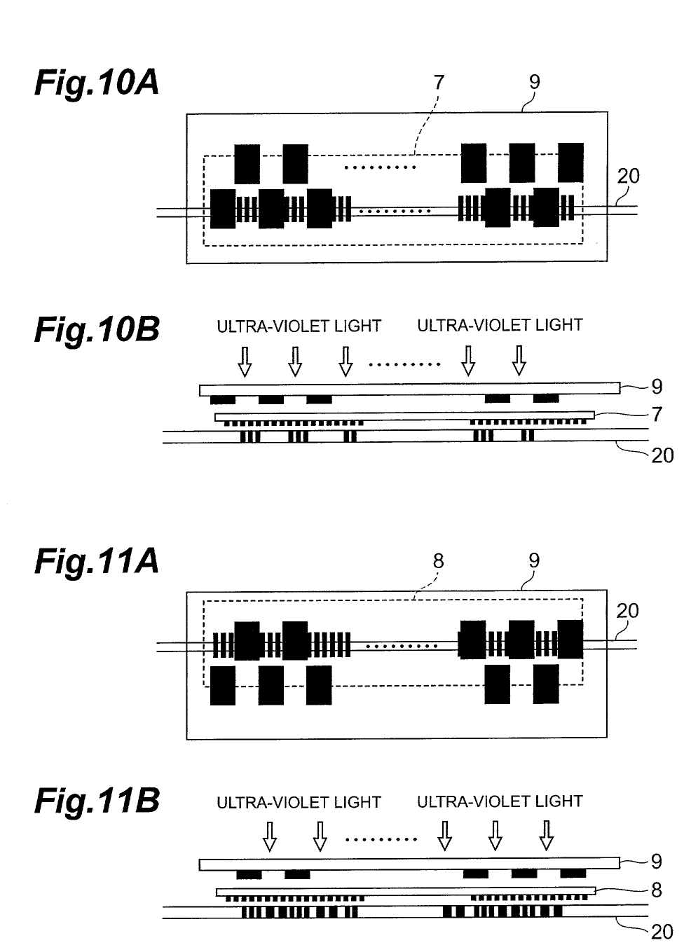

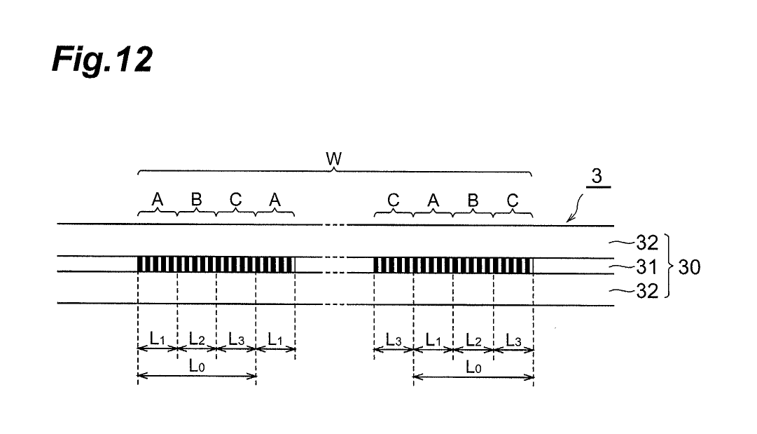

FIG. 10A and FIG. 10B, and FIG. 11A and FIG. 11B are diagrams showing the manufacturing method for the long period grating 2 according to the second embodiment. FIG. 10A and FIG. 11A are diagrams viewed from a direction vertical to the intensity modulation mask, and FIG. 10B and FIG. 11B are diagrams viewed from a direction which is parallel to the intensity modulation mask, and is vertical to the longitudinal direction of the optical fiber 20.

At first, the stripe section of the intensity modulation mask 7 (period Λ₁) and the stripe section of the first row (length L₁ of the light blocking area) of the intensity modulation mask 9 are overlaid on each other and are placed on the optical fiber 20, as shown in FIG. 10A and FIG. 10B. At this time, the intensity modulation masks 7 and 9 are placed such that the stripes of the intensity modulation masks 7 and 9 become perpendicular to the longitudinal direction of the optical fiber 20. Through these two intensity modulation masks 7 and 9, the refractive index change inducing light (ultra-violet light) is irradiated onto the optical fiber 20 at a uniform intensity along the longitudinal direction in a predetermined range with length W. By this, the refractive index modulation with period Λ₁ are created in each first area A of the optical fiber 20. At this point, an element similar to the long period grating 1 of the first embodiment is obtained as an intermediate product.

Then as FIG. 11A and FIG. 11B show, the intensity modulation mask 7 is replaced with the intensity modulation mask 8, the intensity modulation mask 9 is parallel-shifted in a direction perpendicular to the longitudinal direction of the optical fiber 20, the intensity modulation masks 8 and 9 are placed on the optical fiber 20 in a state where the stripe section of the intensity modulation mask 8 (period Λ₂), and the stripe section of the second row of the intensity modulation mask 9 (length L₂ of the light block area) are overlaid on each other. At this time, the intensity modulation masks 8 and 9 are placed such that the stripes of each intensity modulation mask 8 and 9 become perpendicular to the longitudinal direction of the optical fiber 20. And through these two intensity modulation masks 8 and 9, the refractive index change inducing light (ultra-violet light) is irradiated onto the optical fiber 20 at a uniform intensity in a predetermined range along the longitudinal direction with length W. By this, the refractive index modulation with period Λ₂ are created in each second area B of the optical fiber 20.

In the long period grating manufacturing method according to the present embodiment, a part of the intensity modulation mask 7 with a predetermined period Λ₁ is masked by the intensity modulation mask 9, and the refractive index modulation with the period Λ₁ is created in the first area A of the optical fiber 20. Also a part of the intensity modulation mask 8 with a predetermined period Λ₂ is masked by the light intensity modulation mask 9, and the refractive index modulation with the period Λ₂ is created in the second area B of the optical fiber 20. Therefore in the long period grating manufactured by this manufacturing method, the refractive index modulation in each one of the plurality of first areas A is given by the product of the first square wave function (period L_{0,} duty ratio L₁/L₀), where a value in the first area A is 1 and a value in the other area is 0, and the period function of the first period Λ₁ in the predetermined range W. In the same way, the refractive index modulation in each one of the plurality of second areas B is given by the product of the second square wave function (period L₀, duty ratio L₂/L₀), where a value in the second area B is 1 and a value in the other area is 0, and the period function of the second period Λ₂ in the predetermined range W. In other words, the long period grating 2 of the second embodiment is obtained.

When the length from one end to the other end of the range, where the refractive index rising sections are formed at equal intervals with period Λ₁ in the first area A, is regarded as the length L₁ of the first area A, and the length from one end to the other end of the range, where the refractive index rising sections are created at equal intervals with period Λ₂ in the second area B, is regarded as the length L₂ of the second area B, the length L₁ of each one of the plurality of first areas A is not always the same, and the length L₂ of each one of the plurality of second areas B is also not always the same depending on the relative positional relationship of the respective refractive index change inducing light blocking areas when the intensity modulation mask 7 and the intensity modulation mask 9 are overlaid. However, in the case of the long period grating manufactured by the above mentioned manufacturing method, each intensity modulation mask has a predetermined period, so the deviation of the lengths L₁ of each one of the first areas A is smaller than double that of the first period A₁, the deviation of the lengths between each one of the plurality of the first areas A is smaller than double that of the first period Λ₁, the deviation of the lengths L₂ of each on of the plurality of the second areas B is smaller than double that of the second period Λ₂, and the deviation of the lengths between each one of the plurality of the second areas B is smaller than double that of the second period Λ₂. Therefore the first square wave function can be substantially regarded as period L₀ and the duty ratio L₁/L₀, and the second square function can be substantially regarded as period L₀ and the duty ratio L₂/L₀, and the above equations (1) to (6) can be satisfied.

(Third Embodiment)

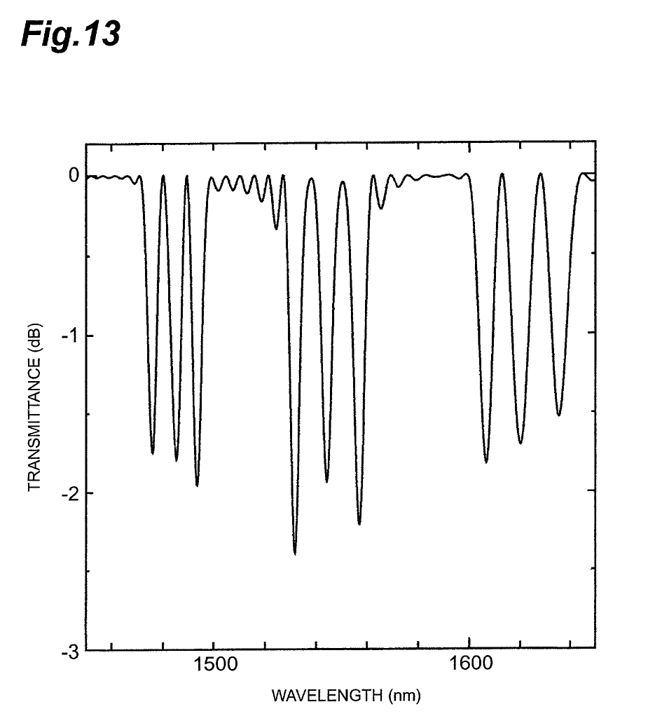

The third embodiment of the long period grating according to the present invention will now be described. FIG. 12 is a diagram showing the long period grating 3 of the third embodiment. FIG. 12 shows a cross-section when the long period grating 3 is cut at the plane which includes the optical axis. In the long period grating 3 shown in FIG. 12, a refractive index modulation with a first period Λ₁ is created at each one of the plurality of first areas A of the core area 31 in a predetermined range W along the longitudinal direction of the silica-based optical fiber 30, which includes the core area 31, where GeO2 has been added, and a clad area 32 surrounding this core area 31, and the refractive index modulation with the second period Λ₂ is created in each one of the plurality of second areas B of the core area 31, and the refractive index modulation with the third period Λ₃ is created in each one of the plurality of third areas C. The first areas A, the second areas B, and the third areas C do not overlap each other, and are sequentially created along the longitudinal direction. The first period Λ₁, the second period Λ₂, and the third period Λ₃ are different from each other.

In a predetermined range W, the refractive index modulation in each one of the plurality of first areas A is given by a product of the first square wave function, where the value in the first area A is 1 and the value in the other area is 0, and the period function of the first period Λ₁, just like the case of the first embodiment. In the same way, in a predetermined range W, the refractive index modulation in each one of the plurality of second areas B is given by the product of the second square wave function, where the value in the second area B is 1 and the value in the other area is 0, and the period function of the second period Λ₂. Also in a predetermined range W, the refractive index modulation in each one of the plurality of third areas C is given by the product of the third square wave function, where the value in the third area C is 1 and the value in the other area is 0, and the period function of the third period Λ₃.

It is preferable that the first square wave function has period L₀ and duty ratio L₁/L₀. However, if the deviation of the lengths L₁ of each one of the plurality of the first areas A is smaller than double that of the first period Λ₁ and the deviation of the lengths between each one of the plurality of the first areas A is smaller than double that of the first period Λ₁, then the first square wave function may have period L₀ and duty ratio L₁/L₀. In the same way, it is preferable that the second square wave function has period L₀ and duty ratio L₂/L₀. However, if the deviation of the lengths L₂ of each one of the plurality of second areas B is smaller than the double of the second period Λ₂, and the deviations between each one of the plurality of the second areas B is smaller than double that of the second period Λ₂, then the second square wave function may have period L₀ and duty ratio L₂/L₀. In the same way, it is preferable that the third square wave function has period L₀ and duty ratio L₃/L₀. However, if the deviation of the lengths L₃ of each one of the plurality of the third areas C is smaller than double that of the third period A₃, and the deviation of the lengths between each one of the plurality of the third area C is smaller than double that of the third period Λ₃, then the third square wave function may have period L₀ and duty ratio L₃/L₀.

It is also preferable that for the period function of the first period Λ₁, the amplitude of the refractive index modulation is the same in each one of the plurality of the first areas A. In the same way, it is preferable that for the period function of the second period Λ₂, the amplitude of the refractive index modulation is the same in each one of the plurality of the second areas B. In the same way, it is preferable that for the period function of the third period Λ₃, the amplitude of the refractive index modulation is the same in each one of the plurality of the third areas C. Also it is preferable that the amplitude of the refractive index modulation in each one of the plurality of the first areas A, the amplitude of the refractive index modulation in each one of the plurality of the second areas B, and the amplitude of the refractive index modulation in each one of the plurality of the third areas C are the same.

For the transmission characteristic of the long period grating 3 according to the present embodiment, a component due to the refractive index modulation in each one of the plurality of first areas A, a component due to the refractive index modulation in each one of the plurality of the second areas B, and a component due to the refractive index modulation in each one of the plurality of the third areas C are superimposed. The component due to the refractive index modulation in each one of the plurality of the first areas A is the same as that shown in the first embodiment. The component due to the refractive index modulation in each one of the plurality of the second areas B is also the same as that shown in the first embodiment, and the component due to the refractive index modulation in each one of the plurality of the third areas C is also the same as that shown in the first embodiment.

Now an example (example 4) of the long period grating 3 according to the third embodiment will be described. FIG. 13 is a diagram showing the transmission characteristic of the long period grating in the example 4. In the long period grating in example 4, L₀=4.5 mm, L₁=L₂=L₃=1.5 mm, Λ₁=360 μm, Λ₂=365 μm, Λ₃=370 μm, the number of the first areas A is 11, the number of the second areas B is 11, the number of the third areas C is 11, and the length of the predetermined range W is 49.5 mm.

As FIG. 13 shows, the long period grating in the example 4 has loss peaks at around wavelengths 1530 nm, 1545 nm and 1560 nm respectively (based on the first term of the right side of the equation (3)). The loss peak at around the wavelength 1530 nm is due to the refractive index modulation with the first period Λ₁ in the first area A. The loss peak at around the wavelength 1545 nm is due to the refractive index modulation with the second period Λ₂ in the second area B. And the loss peak at around the wavelength 1560 nm is due to the refractive index modulation with the third period Λ₃ in the third area C.

The long period grating in example 4 also has loss peaks at around the wavelengths 1475 nm, 1485 nm, 1495 nm, 1605 nm, 1620 nm, and 1635 nm respectively (based on the third term of the right hand side of the equation (3)). These loss peaks can exist in the signal light wavelength band by appropriately setting L₀. In this way, the long period grating in the example 4 has a small size, even if a plurality of loss peak wavelengths exist in the signal light wavelength band.

What is claimed is:

1. A long period grating where the refractive index in a predetermined range is periodically modulated in a several hundred μm order along the longitudinal direction of an optical wave guide, wherein a plurality of first areas are arranged discretely in said predetermined range, and the refractive index at each position in said first area is modulated to a refractive index that is the same as the refractive index modulated at a first period all through said predetermined range.

2. The long period grating according to claim 1, wherein the deviation of the lengths of said first areas and the deviation of the lengths between the first areas are both smaller than double that of said first period.

3. The long period grating according to claim 1, wherein the amplitude of the refractive index modulation of each area of said first areas is the same as one another.

4. The long period grating according to claim 1, comprising one or more area groups of a plurality of areas arranged in an area other than said first areas in said predetermined range, wherein the refractive index at each position of each area has been modulated to a refractive index the same as the refractive index modulated at a unique period which is different from said first period, all through said predetermined range.

5. The long period grating according to claim 4, wherein the areas of each group are sequentially arranged without space in said predetermined range.

6. The long period grating according to claim 4, wherein the deviation of the lengths of each one of said areas and the deviation of the lengths between each area are set to values smaller than double that of the refractive index period of said area in said predetermined range.

7. The long period grating according to claim 4, wherein the amplitude of the refractive index modulation of each one of said areas is the same within a same group.

8. The long period grating according to claim 7, wherein the amplitude of the refractive index modulation of each one of said areas is the same.

9. The long period grating according to claim 7, wherein a second area is arranged between said first areas respectively, and the following four equations are satisfied where the arrangement period of said first areas and second areas is L₀, the setting length is L₁ and L₂ respectively, the refractive index period is A₁ and A₂ respectively, the refractive index period of the long period grating to be required for obtaining a loss peak at the shortest wavelength of the wavelength band in use is Λ_{S}, and the refractive index period of the long period grating to be required for obtaining a loss peak at the longest wavelength of said band is Λ_{L}.
$$\begin{matrix}\frac{{Λ}_{1} {L}_{0}}{{L}_{0} + {Λ}_{1}} < {Λ}_{S} \\ \frac{{Λ}_{2} {L}_{0}}{{L}_{0} + {Λ}_{2}} < {Λ}_{S} \\ {Λ}_{L} < \frac{{Λ}_{1} {L}_{0}}{{L}_{0} - {Λ}_{1}} \\ {Λ}_{L} < \frac{{Λ}_{2} {L}_{0}}{{L}_{0} - {Λ}_{2}} .\end{matrix}$$

10. A making method of a long period grating comprising steps of:
preparing a first intensity modulation mask where a mask pattern is created according to a predetermined period in the entire area along a predetermined range, and a second intensity modulation mask where light blocking sections are arranged between a plurality of light transmission sections along the predetermined range;
overlaying these two intensity modulation masks on each other and placing them on a processing target optical wave guide; and
creating a long period grating by irradiating a refractive index change inducing light which transmits through these two masks on said optical wave guide to cause the refractive index change.

11. The long period grating manufacturing method according to claim 10, wherein a plurality of masks with different mask patterns are prepared as first intensity modulation masks, a plurality of masks with a different arrangement of light transmission sections are prepared as second intensity modulation masks, and the arrangement of masks and the irradiation of refraction index change inducing light are repeated with changing the combination of the first intensity modulation mask and the second intensity modulation mask.
